(19) United States
(12) Patent Application Publication
(10) Pub. No.: US 2020/0110431 A1
(43) Pub. Date: Apr. 9, 2020

(54) CONTROL ELEMENT FOR A HOUSEHOLD APPLIANCE AND HOUSEHOLD APPLIANCE

(71) Applicant: BSH Hausgeräte GmbH, Munich (DE)

(72) Inventors: Reinhard Fleissner, Altenmarkt a.d. Alz (DE); Anton Osenstätter, Traunstein (DE); Manuel Schatz, Schechen (DE)

(21) Appl. No.: 16/499,881

(22) PCT Filed: May 8, 2018
(86) PCT No.: PCT/EP2018/061849

§ 371 Date: Oct. 1, 2019

(30) Foreign Application Priority Data
May 30, 2017 (DE) 10 2017 209 056.1

(51) Int. Cl. G05G 1/10

(52) U.S. Cl. CPC G05G 1/105; C08J 5/043

(57) ABSTRACT

An operating element for a household appliance includes a base body having a material, which includes a matrix and a filler embedded in the matrix. The filler has a percentage by weight of 5%-30% of the material and is configured to increase a mechanical strength of the material and to increase a chemical resistance of the material.

The present invention relates to an operating element for a household appliance and a household appliance with such an operating element.

Household appliances are conventionally operated using rotating selection facilities, such as rotating knobs for example. A number of knobs can be provided, which in combination determine an operating mode for the household appliance. Provision can be made for example for an oven to have a first rotating knob for selecting a specific cooking temperature and a second rotating knob for selecting an operating variant, such as hot air, top heat or bottom heat. Turning the respective rotating knob to a predefined angular position actuates a corresponding selection. For example an arrow is provided on the rotating knob and symbols for the selectable positions are arranged around the rotating knob, for example on an operating panel. Such rotating knobs are made of plastic for example for reasons of cost. On the one hand this has the advantage that light-permeable materials are also available to light the rotating knob from the rear, allowing reliable selection, even if the room in which the household appliance is operated is dark. However plastics have the disadvantage that they have a limited temperature resistance and a limited resistance to chemical cleaning agents. This can lead to premature aging of such a rotating knob.

A rotating selection facility with a front display surface that can be lit from the rear is known from DE 10 2014 201 430 A1. WO 2012/139926 A1 describes an operating knob made of plastic for a thermal household appliance that conveys the impression of a metal operating knob.

Against this background one object of the present invention is to provide an improved operating element for a household appliance.

An operating element for a household appliance is therefore proposed with a base body having a material which comprises a matrix and a filler embedded in the matrix. The filler has a percentage by weight of 5%-30% of the material and is designed to increase a mechanical strength of the material and to increase a chemical resistance of the material.

Such an operating element has the advantage that a service life of the operating element is increased. This is particularly true if the operating element is frequently in contact with solvents and/or cleaning agents.

The operating element is configured as a rotating knob for example. The base body then has a round shape for example, it being possible to provide a receiver for a rotation axis. The rotating knob is positioned or mounted on a corresponding rotation axis of the household appliance to be operated for example. The rotating knob can also have various further elements, which are arranged on or at the side of the base body, for example a coating and/or a dial.

The base body is produced for example from the liquefied material in an injection molding procedure. It is also conceivable for the base body to be milled from a solid block of material. Various further processing steps are also possible for producing the base body and/or for producing the operating element from the base body.

A matrix refers in particular to the part of the material into which the filler is introduced. The matrix comprises in particular plastics, for example polyamide. A filler essentially refers to any addition to the material which does not consist of the matrix material. The matrix is in particular suitable for shaping a cohesive body of any form.

A percentage by weight of 5%-30% means that for example a kilogram of the material contains 50 to 300 g of the filler, the remainder being the matrix material in particular.

The filler is for example an inorganic substance, such as glass, minerals and/or metal. The filler is in particular in the form of small bodies, such as balls, irregularly shaped pieces, small plates and/or fibers, with a diameter less than 1 mm. Fibers in particular can reach a length of several centimeters.

The filler is designed to increase the mechanical strength of the material. The material strength here is defined in particular by the modulus of elasticity, which is specified as a pressure, for example in Pa, N/mm² or kg/(ms²), in the International System of Units. The modulus of elasticity can also be referred to as mechanical stress. The material with the filler therefore has a greater modulus of elasticity than a material that only consists of the matrix material.

The filler is also designed to increase the chemical resistance of the material, in particular to cleaning agents, for example standard household cleaning agents. Chemical resistance refers in particular to an ability of the material to resist chemicals. A material is more capable of resistance, the less it changes its material properties when subject to the action of and/or contact with a chemical. The material properties here include the mechanical, physical and also chemical properties of the material. The modulus of elasticity for example is a mechanical property. Thermal conductivity or optical properties are examples of physical properties. Composition is an example of a chemical property.

Standard household cleaning agents refer in particular to cleaning agents which are freely marketed and available, in particular in Germany and Europe. Ingredients of such cleaning agents include alcohols, such as ethanol, alkalis, such as ammonia, sodium hydroxide and/or potassium hydroxide, surfactants, acetone, benzene and/or glycols. The chemical resistance of the material to such a cleaning agent is increased for example, if the resistance of the material to an ingredient of the cleaning agent is increased.

The increased chemical resistance means in particular that the sensitivity of the material to media or chemicals producing environmental stress cracking is reduced. Media that produce environmental stress cracking for example cause non-homogeneous softening of the material. Environmental stress cracking (ESC) takes place for example in materials with frozen mechanical stress. This is the case for almost all materials made of thermoplastic plastics for example, as such mechanical stresses cannot be avoided as the molten mass cools. If such a material comes into contact with a chemical, which reduces the modulus of elasticity locally for example, this can cause the frozen mechanical stress to be greater than the modulus of elasticity and what is known as environmental stress cracking to form there. Environmental stress cracking can however also result due to a force acting externally on the material, in particular if the material is or was recently in contact with a corresponding medium. Environmental stress cracking can range widely in size, in particular from micrometers to millimeters. Environmental stress cracking causes the component in which it occurs, for example the operating element, to age prematurely and/or results in premature component failure. The operating element made of the material can improve this.

The standard ISO 22088 for example describes test methods which can be used to test the plastic body for its susceptibility to environmental stress cracking when in contact with chemicals.

According to one embodiment of the operating element the base body is made of the material. This means that the base body of this embodiment comprises no further components.

According to a further embodiment of the operating element the matrix is a transparent plastic matrix and the filler is also designed to provide a predefined scattering for light coupled into the material.

A plastic matrix comprises for example plastics such as poly(methyl methacrylate) (PMMA), polyamide (PA), polycarbonate (PC), polyethylene (PE), polypropylene (PP) and further polymers. The polymers in particular form an amorphous matrix, in other words there is no long-range order as in crystals. It can also be said that the polymers are glass formers, the solid state of which corresponds to that of a super-cooled liquid. Heating such a plastic matrix above a glass transition temperature based on the plastics therein causes the plastic matrix to become plastically formable.

Transparent here means that a body consisting of the matrix is transparent to light, in particular with wavelengths in the visible range. In other words light passes through such a body and is only slightly attenuated in the process. Light attenuation due to the transparent plastic matrix is in particular below 50%, advantageously below 20% and particularly advantageously below 10% when passing through a 1 mm thick plate of the plastic matrix, without taking into account reflection losses.

Scattering of light in the material is caused in particular by the filler. Scattering means for example that a light beam with a specific propagation direction is diverted or deflected. No absorption in particular then takes place. Scattering is caused by light being fractured or refracted at filler particles in the matrix. When a light beam strikes a filler particle with a curved surface, such as a fiber, in the material, the light beam is refracted during the transition from the matrix into the fiber as a function of the relationship between the refraction index of the filler material and the plastic matrix and the angle of incidence. This deflects the light beam from its original propagation direction.

In particular a light beam can be refracted multiple times as it passes through the base body made of the material. As a result it appears to an observer of the base body, which is lit from the rear for example, as if the base body itself is lit. The more frequently the light beam is refracted, the more difficult it is to identify the point at which or the direction in which light is coupled into the base body. This advantageously allows the entire base body to be illuminated homogeneously with a single light source, while the light source itself cannot be identified. Non-homogeneities in the plastic matrix mean that a light beam can also be scattered at such a non-homogeneity.

The degree to which such a material scatters light can be described for example by way of the mean free path length of a light beam or photon in the material, before it strikes a filler particle and is refracted. The mean free path length here corresponds to a mean value of the path covered by a light beam or photon in a straight line, in other words without being refracted, in the material. A total or differential scattering cross-section can also be determined for such a material, describing a degree of light scattering.

According to a further embodiment of the operating element the transparent plastic matrix is made of polyamide.

According to a further embodiment of the operating element the filler consists of glass fibers, glass balls, carbon fibers, aramid fibers, pigments and/or mineral fillers.

The chemical structure and composition of the filler in particular influences the material properties. The geometric shape of the filler can also influence for example the mechanical, physical and/or chemical properties of the material. Fibers in particular have an elongated shape, sections of which are straight or curved. Mineral fillers, such as sheet silicates, can also have a plate-type shape.

According to a further embodiment of the operating element the mechanical strength of the material has a modulus of elasticity greater than 3300 MPa.

According to a further embodiment of the operating element the material has a long-term temperature resistance of above 100° C., in particular up to 110° C., and a short-term temperature resistance of above 120° C.

The long-term temperature resistance here means in particular that the material, when it is heated in the long term, in other words for example for quite a long period, of for example several hours or days, to above 100° C., in particular up to 110° C., retains its characteristic properties and is not destroyed by the thermal stress. This ensures that the operating element remains functional without restriction even in operating states in which such high temperatures occur. The material also has a short-term temperature resistance of above 120° C. Short-term here means for example a time period of several seconds or minutes.

According to a further embodiment of the operating element the filler consists of glass fibers with a diameter of 10-20 μm.

Glass fibers themselves are made of glass, in particular SiO₂, and are a very favorable filler. This means the operating element can be produced at low cost.

According to a further embodiment of the operating element the filler has a percentage by weight of 10%-20% of the material.

According to a further embodiment of the operating element the filler has a percentage by weight of 12%-17% of the material.

According to a further embodiment of the operating element a lighting facility is provided to light the base body from the rear.

In this embodiment the operating element can be lit from the rear, in other words in particular from a side of the operating element facing away from the user and toward a household appliance. This advantageously allows faster and easier perception of a current selection position of the operating element and also allows use of the operating element in a dark environment. Shading of an external lighting facility is also effectively prevented. Such an operating element also appears to be of high quality to a user.

The lighting facility can be configured as a lightbulb, an LED, a gas discharge lamp, a fluorescent tube and/or a laser. The lighting facility can also be configured as a wide-band light source, which generates a broad spectrum of wavelengths, or as a narrow-band light source, which generates a narrow spectrum of wavelengths, or even a monochromatic light source, which essentially generates just one wavelength. Wide-band here means for example a spectral bandwidth of above 100 nm, narrow-band means for example a spectral bandwidth of below 100 nm and monochromatic means for example a bandwidth below 10 nm.

The lighting facility can be arranged for example in a hollow provided for the purpose in the base body, with two electrically conducting contacts being provided on the base body to supply power to the lighting facility. Alternatively and/or additionally the lighting facility can comprise a light guide, by means of which for example light from a remotely disposed light source can be guided to the base body. The light guide can also be designed to form a beam, for example to focus, the light.

The light generated by the lighting facility is coupled in particular into the base body. In the base body the light is scattered in particular by the filler, so that a radiation direction of the light is camouflaged as a function of the total scattering cross-section or the mean free path length. This gives an impression of diffuse light for the entire base body and therefore also the operating element. In particular it means the light is not direction-dependent.

According to a further embodiment of the operating element a facility is provided to supply patterns, in particular numbers, letters and/or symbols, on the base body. The patterns can be lit by light coupled into the base body.

The facility is a metal sheet for example, in particular a stainless steel sheet, which is fastened to the front of the operating element and which has holes at certain points, produced by drilling or milling for example, to allow sight of the base body at said points. The facility can also comprise a coating layer for example, which is applied to parts of the base body at least. In particular the facility can also be designed to influence a light color of the light coupled into the base body in a predefined manner by means of colored layers and/or colored elements. For example different symbols have different colors. Alternatively and/or additionally the facility can also be configured as a filter screen with a graphic. For example the filter screen is formed from a transparent material which does not scatter light. For example the filter screen is coated on at least one side with a coating layer that does not allow the passage of light and is removed in parts to show the graphic. Provision can also be made for the coating layer to have a predefined thin layer thickness in places, so that a defined proportion of the light passes through the thin coating layer, allowing different light intensities to be revealed at different points on the filter screen.

Such a facility can simplify the use of the operating element in particular, as a selection position is clearer and therefore more intuitive.

According to a further embodiment of the operating element the operating element is configured as a slide control, an operating knob, a rotating knob, a key, a switch and/or a button.

A household appliance with at least one operating element is also proposed. The operating element is configured according to one of the embodiments cited above.

According to one embodiment of the household appliance it is configured as a cooking appliance and/or a water-conducting household appliance.

For example the household appliance is configured as an oven, a microwave, a cooker and/or a steam cooker, a dishwasher, a washing machine, a water heater, a coffee machine and/or an extractor hood.

Further possible implementations of the invention comprise combinations of features or embodiments described above or in the following with regard to the exemplary embodiments even if these are not cited specifically. The person skilled in the art will also add individual aspects to improve or complete the respective basic form of the invention.

Further advantageous configurations and aspects of the invention are set out in the subclaims and the exemplary embodiments of the invention described in the following. The invention is also described in more detail based on preferred embodiments with reference to the accompanying figures.

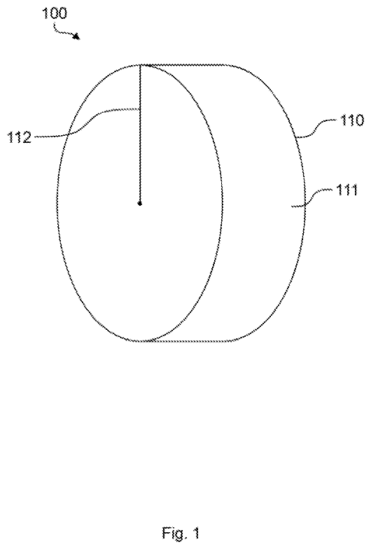

FIG. 1 shows a schematic view of an exemplary embodiment of an operating element for a household appliance;

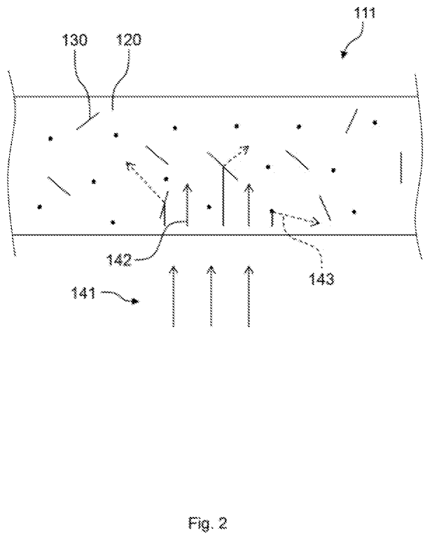

FIG. 2 shows a schematic detail of a plane-parallel layer of a material from a matrix with filler embedded in the matrix, into which light is coupled;

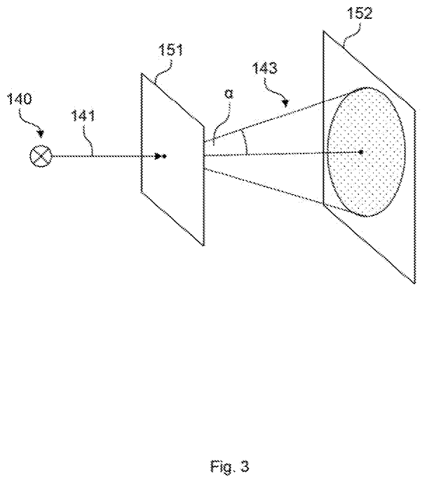

FIG. 3 shows a schematic view of a material with a specific total scattering cross-section; and

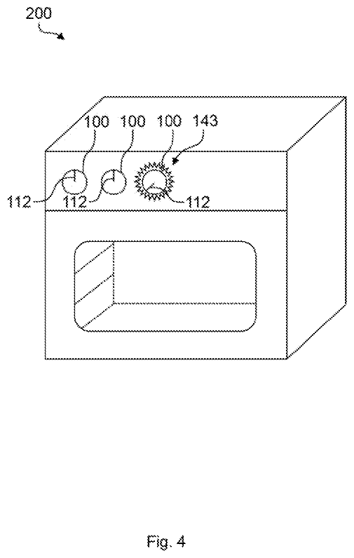

FIG. 4 shows a schematic view of an exemplary embodiment of a household appliance with an operating element.

Identical elements or those of identical function are shown with the same reference characters in the figures, unless otherwise specified.

FIG. 1 shows a schematic view of an exemplary embodiment of an operating element 100 for a household appliance 200 (see FIG. 4), for example an oven. The operating element 100 in FIG. 1 is configured as a rotating knob. The rotating knob 100 has a round base body 110, which is formed from a material 111, which consists of a matrix 120 (see FIG. 2) and filler 130 (see FIG. 2). A facility 112 is arranged on a front face of the base body 110, in the present instance configured as a pointer, which a user of the rotating knob 100 can use to read a degree of rotation of the rotating knob 100 relative to a zero position.

The material 111 of the base body 110 here consists of a matrix 120 of polyamide with a percentage by weight of 15% of the filler 130, the filler 130 here being glass fibers. The polyamide 120 has the advantage that it is transparent and has a high chemical resistance to standard household cleaning agents as well as advantageous mechanical and physical properties. The use of 15% glass fibers 130 in particular improves the chemical resistance of the material 111, in particular reducing the susceptibility of the material 111 to media producing environmental stress cracking. The mechanical resilience of the material 111 is also improved. The material 111 advantageously has a modulus of elasticity of at least 3300 MPa. Further advantageous properties of the material 111 are described below with reference to FIG. 2.

FIG. 2 shows a schematic detail of a plane-parallel layer of the material 111 from a matrix 120 made of polyamide and filler 130 embedded in the polyamide 120, which can be used for example for the base body 110 of the operating element 100 in FIG. 1. The filler 130 is glass fibers and glass balls. The glass fibers 130 and glass balls 130 are distributed statistically in the polyamide 120. For reasons of clarity the glass fibers 130 here are shown as bars but they can also have a curved profile in the polyamide 120. Light 141, for example from a light-emitting diode (not shown) is radiated from below in FIG. 2 onto the plane-parallel layer. The light 141 is coupled across the interface into the material 111. The coupled-in light 142 is propagated in the material 111, initially in the original direction. When the coupled-in light 142 strikes a glass fiber 130 or glass ball 130, there is a high probability that the light 142 will be refracted, in other words diverted or scattered. This is shown by way of example for three light beams, which are referred to as scattered light 143 and shown with a broken line after scattering. The scattered light 143 is propagated in particular in a direction that is different from the original direction in the material 111. A scattered light beam 143 can also strike a glass fiber 130 or glass ball 130 again and be scattered again. It is a function in particular of the total scattering cross-section or the mean free path length of the material 111 how frequently a coupled-in light beam 142 is scattered as it passes through the material 111. The more frequently a light beam 142, 143 is scattered, the more homogeneously an operating knob 100 (see FIG. 1 or 4) is lit by a lighting facility 140 (see FIG. 3).

FIG. 3 shows a schematic view of a rectangular plate 151 made of a material 111 with a specific total scattering cross-section. The material can be used for example for the base body 110 of the operating element 100 in FIG. 1. A lighting facility 140, configured here as a laser, emits a collimated light beam 141. The light beam 141 strikes a rectangular plate 151, which is made of the material 111 in FIG. 1 or 2 for example. The light beam 141 is scattered as it passes through the plate 151. After the plate 151 therefore the light beam 141 is no longer propagated collinearly but conically in a scattered light cone with opening angle α. The scattered light 143 therefore illuminates for example a circular surface instead of a single point on a subsequent plate 152. The greater the opening angle α of the scattered light cone, the greater the total scattering cross-section of the material 111. The intensity of the scattered light within the scattered light cone can also vary. The material preferably has such a large total scattering cross-section that the scattered light cone has an opening angle α of approximately 90°, with the intensity of the scattered light in the scattered light cone not varying by more than a factor 100. For example the intensity of the scattered light in the direction of passage, in other words where α=0°, is 5 W/m² and the intensity of the scattered light where α=89° is 0.05 W/m².

FIG. 4 shows a schematic view of an exemplary embodiment of a household appliance 200 with three operating elements 100, which are arranged on a front operating panel of the household appliance 200. The household appliance 200 here is configured as an oven by way of example. The three operating elements 100 are configured as rotating knobs, like the rotating knob 100 shown in FIG. 1, and have a facility 112 on their faces facing away from the oven 200. The rotating knobs 100 can each be lit from the rear with a lighting facility 140, which is arranged here in such a manner that it cannot be seen behind the rotating knobs. In the illustrated example only the right rotating knob 100 is not in the rest position. The oven 200 is configured in such a manner for example that a respective lighting facility 140 is activated when a respective rotating knob 100 is moved from its rest position to select a specific function of the oven 200. As this only applies to the right rotating knob 100 here, this is the only one lit, as can be seen from the scattered light 143. The setting of the rotating knob 100 can be read quickly and reliably even from a significant distance as a result of the scattered light 143 in conjunction with the facility 112.

Although the present invention has been described based on exemplary embodiments, it can be modified in many different ways.

A large plurality of further forms of the operating element and the facility for supplying patterns is also possible in particular.

Reference characters used:
100 Operating element
110 Base body
111 Material
112 Facility
120 Matrix
130 Filler
140 Lighting facility
141 Light
142 Coupled-in light
143 Scattered light
151 Plate
152 Plate
200 Household appliance
α Scatter angle

1-15. (canceled)

16. An operating element for a household appliance, said operating element comprising a base body having a material, which comprises a matrix and a filler embedded in the matrix, the filler having a percentage by weight of 5%-30% of the material and configured to increase a mechanical strength of the material and to increase a chemical resistance of the material.

17. The operating element of claim 16, wherein the base body is made of the material.

18. The operating element of claim 16, wherein the matrix is a transparent plastic matrix and the filler is configured to provide a predefined scattering for light coupled into the material.

19. The operating element of claim 18, wherein the transparent plastic matrix is made of polyamide.

20. The operating element of claim 16, wherein the filler is made of glass fibers, glass balls, carbon fibers, aramid fibers, pigments and/or mineral fillers.

21. The operating element of claim 16, wherein the mechanical strength of the material has a modulus of elasticity greater than 3300 MPa.

22. The operating element of claim 16, wherein the material has a long-term temperature resistance of above 100° C. and a short-term temperature resistance of above 120° C.

23. The operating element of claim 16, wherein the material has a long-term temperature resistance of above 110° C. and a short-term temperature resistance of above 120° C.

24. The operating element of claim 16, wherein the filler is made of glass fibers with a diameter of 10-20 μm.

25. The operating element of claim 16, wherein the filler has a percentage by weight of 10%-20% of the material.

26. The operating element of claim 16, wherein the filler has a percentage by weight of 12%-17% of the material.

27. The operating element of claim 16, further comprising a lighting facility configured to light the base body from a rear.

28. The operating element of claim 16, further comprising a facility configured to supply a pattern on the base body, with the pattern capable of being lit by light coupled into the base body.

29. The operating element of claim 16, wherein the pattern includes numbers, letters and/or symbols.

30. The operating element of claim 16, wherein the operating element is configured as a slide control, an operating knob, a rotating knob, a key, a switch and/or a button.

31. A household appliance, comprising an operating element, said operating element comprising a base body having a material, which comprises a matrix and a filler embedded in the matrix, the filler having a percentage by weight of 5%-30% of the material and configured to increase a mechanical strength of the material and to increase a chemical resistance of the material.

32. The household appliance of claim 31, wherein the household appliance is configured as a cooking appliance and/or a water-conducting household appliance.
